(19) United States
(12) Patent Application Publication
(10) Pub. No.: US 2026/0287031 A1
(43) Pub. Date: Sep. 24, 2026

(54) RADIAL FREEWHEEL CLUTCHES AND PAWLS

(71) Applicant: Means Industries, Inc., Saginaw, MI (US)

(72) Inventors: Masayuki Uchihashi, Yokohama Kanagawa (JP); Douglas Brubaker, Midland, MI (US); Kyle Ball, Saginaw, MI (US); Eric King, Caro, MI (US); Scott Bostian, Kingston, MI (US); Vijay Pathak, London (CA)

(21) Appl. No.: 19/128,430

(22) PCT Filed: Dec. 18, 2024
(86) PCT No.: PCT/US2024/060641

§ 371 Date: May 8, 2025

Related U.S. Application Data
(60) Provisional application No. 63/611,707, filed on Dec. 18, 2023.

(51) Int. Cl. F16D 41/12; F16D 27/102

(52) U.S. Cl. CPC F16D 41/12; F16D 27/102

(57) ABSTRACT

A freewheel clutch includes a race including circumferentially spaced notches, each including first and second flanks, and a pawl including a leg having relatively radial inner and outer surfaces, side surfaces extending between the radial inner and outer surfaces, a thickness between the radial inner and outer surfaces, and a width between the side surfaces greater than the thickness. The pawl also includes a knuckle at a forward portion of the leg and having a forward end surface engageable with one of the flanks of the notches of the race in a detent position of the pawl with respect to the race, and being configured in cooperation with the notches of the race to restrain the pawl from advancing into the detent position at rotational speeds exceeding a detent-blocking rotational speed of the race relative to the pawl.

### CROSS-REFERENCE TO RELATED APPLICATION

This is a PCT application claiming priority to U.S. Provisional Patent Application 63/611,707, filed on Dec. 18, 2023.

### TECHNICAL FIELD

This disclosure relates generally to mechanical apparatuses for coupling and decoupling rotational elements and, more particularly, to radial freewheel clutches and pawls.

### BACKGROUND

In general, a typical freewheel clutch fundamentally includes at least one rotatable clutch member or race and at least one locking element displaceable into and out of detent with the race to prevent or permit relative rotation between the race and the locking element. In radial freewheel clutches, the races are radially adjacent such that an outer race circumscribes an inner race, and the locking elements are configured for radial engagement of the races and may include balls, rollers, sprags, pawls (radial struts), or other radial locking elements. In axial freewheel clutches, the races are axially adjacent, and the locking elements are configured for axial engagement of the races and may include planar struts or other axial locking elements.

Some freewheel clutches, for example, mechanical diodes (MDs), may be passive couplings having passive locking elements, and races that rotate in a circumferential direction to overrun the passive locking elements in a freewheel state, and that rotate in an opposite circumferential direction to lockingly engage the passive locking elements in a drive state where the race and the passive locking elements rotate together or where the race and the locking elements are both stationary in a braked state. But other freewheel clutches may be active couplings having races, and pawls that may be passively biased toward or away from a detent position with the races and may be selectively actuatable into and/or out of the detent position with the races. In a specific example, an electric controllable mechanical diode (eCMD) may include a rotatable race and a pawl that is selectively actuatable into or out of detent with the rotatable race and that may be carried by a fixed race. In another specific example, a dynamic controllable clutch (DCC) may include first and second relatively rotatable races, and one or more pawls carried by at least one of the races and selectively actuatable into and/or out of detent with at least one of the races to prevent or permit relative rotation between the races in at least one circumferential direction. Some DCC's, and even some eCMDs, may have multiple oppositely-oriented pawls, including one or more clockwise-oriented pawls and one or more counterclockwise-oriented pawls, that are independently actuatable to achieve four clutch modes, as follows: 0/0—where races are disengaged from one another in a freewheel asynchronous mode; 1/0—where a first race is engaged to a second race in a first unidirectional synchronous mode; 0/1—where the second race is engaged to the first race in a second unidirectional synchronous mode; and 1/1—where the first and second races are engaged to one another in a bidirectional synchronous mode, for example, to facilitate a powertrain drive and regenerative mode or to provide bidirectional vehicle hill lock functionality.

Although such clutches are commercially successful, a problem can arise when a radial pawl is biased by a compression spring that has a coil axis oriented radially with respect to a rotational axis of a race. Specifically, when the radial pawl is carried by a race that rotates at high speeds, for example, on the order of 7,000 RPM or greater, the radially oriented compression spring may experience significant centrifugal forces and/or friction with adjacent surfaces of the race that can impede performance of the spring specifically and the clutch generally. Another problem can arise when the radial pawl carried by a first race is inadvertently allowed to move toward a detent position with a second race rotating at a different speed with respect to the first race. Specifically, when the first and second races are rotating with a high speed difference therebetween, engagement of the radial pawl into notches of the second race can cause instantaneous clutch failure.

### SUMMARY

According to a first aspect of the present disclosure, there is provided a clutch, comprising: a race, a radial pawl, and a torsion spring carried by the race. The race includes a rotational axis and a diameter extending through the rotational axis. The radial pawl is carried by the race. The torsion spring includes: a coil portion with a coil axis oriented transversely with respect to the diameter of the race; a first leg extending away from the coil portion and bearing against the race; and a second leg extending away from the coil portion and bearing against the radial pawl.

According to other aspects of the present disclosure, the clutch of the first aspect further includes any of the following features, including any technically-feasible combination of the following features:
the torsion spring biases the radial pawl in a radially outward direction with respect to the race;
a coil axis of the torsion spring is substantially parallel to the rotational axis of the race and substantially perpendicular to the diameter of the race;
the torsion spring is a double torsion spring including: first and second coaxial coils axially spaced apart along the coil axis;
the first leg of the torsion spring is a split outboard reaction leg including a first portion extending tangentially away from an axially outboard portion of the first coil and a second portion extending tangentially away from an axially outboard portion of the second coil;
the second leg of the torsion spring is a unitary inboard action leg including a first portion extending tangentially away from an axially inboard portion of the first coil and a second portion extending tangentially away from an axially inboard portion of the second coil;
the torsion coils each include at least three complete revolutions;
the first and second legs have a compression angle between −5° and 10° and an extension angle between 10° and 35° degrees;
the race includes: a radially outer circumferential surface; a radially inner circumferential surface; a first planar face; a second planar face; a pawl pocket between the first and second planar faces; and a spring pocket between the planar faces and open to the pawl pocket, and having a coil socket to receive the coil portion of the torsion spring;
the spring pocket also has a leg retainer to retain the first leg of the torsion spring;
the pawl pocket includes: a pawl toe socket having a semi-cylindrical interior surface, a pawl heel seat circumferentially opposed to the pawl toe socket, and an actuator pin gap between the pawl toe socket and the pawl heel
the race also includes: a pawl toe socket wall at least partially defining the pawl toe socket, and a pawl stop protruding radially outwardly with respect to the pawl toe socket wall to limit travel of the pawl;
the race also includes an actuator pin passage extending radially through a portion of the race and into the actuator pin gap of the pawl pocket;
the radial pawl includes: a toe carried in the pawl toe socket and having a semi-cylindrical pivot surface cooperative with the semi-cylindrical interior surface of the pawl toe socket, a heel having a rear surface engageable with the pawl heel seat, and a leg extending away from the heel beyond the toe and terminating in a knuckle having a detent-blocking protuberance;
the heel has a flat bottom surface and a protuberance between the bottom and rear surfaces of the heel;
the rear surface of the heel is excurvate and the pawl heel seat is incurvate;
the clutch further comprising: a second race circumscribing the race and including an internal array of circumferentially spaced notches to receive a portion of the radial pawl in a deployed position of the radial pawl;
the race is rotatable about the rotational axis and the second race is also rotatable about the rotational axis in the same or opposite circumferential direction with respect to the race;
the clutch further comprising: an outward radial pawl disposed radially outward with respect to the second race and having an engagement end configured to engage an external array of circumferentially spaced notches of the second race in a deployed position of the outward radial pawl;
the radial pawls are selectively actuatable such that the clutch constitutes an integrated dynamic controllable clutch (DCC) and electrically controllable mechanical diode (eCMD);
the radial pawl includes axially opposite side surfaces and sensor lobes protruding away from the axially opposite side surfaces;
the clutch further comprising: a retainer plate coupled to an axially facing side surface of the race, and having a sensor window corresponding to one of the sensor lobes; and/or
the race includes an axially facing internal side surface facing an axially facing side surface of the radial pawl, and a lobe pocket in the axially facing internal side surface and corresponding to one of the sensor lobes.

According to a second aspect of the present disclosure, there is provided a freewheel clutch radial pawl, comprising a foot, a leg, and a knuckle. The foot includes: a toe having a pivot surface defining a pivot of the pawl; a heel having a rear surface; and a medial portion extending in a rearward direction away from the toe and toward the heel. The leg extends away from the heel in a forward direction beyond the toe, and the leg includes a center of gravity disposed at a forward location of the pawl relative to the pivot of the pawl. The knuckle extends away from the leg and has a forward end surface.

According to other aspects of the present disclosure, the freewheel clutch radial pawl of the second aspect further includes any of the following features, including any technically-feasible combination of the following features:
the knuckle also includes a detent-blocking protuberance extending longitudinally between a relatively radial outer surface of the leg and the forward end surface of the knuckle and protruding in a direction away from the relatively radial outer surface of the leg;
the knuckle also includes a spring-engaging protuberance extending longitudinally between a relatively radial inner surface of the leg and the forward end surface of the knuckle and protruding in a direction away from the relatively radial inner surface of the leg;
the knuckle also includes axially opposite side surfaces and sensor lobes protruding away from the axially opposite side surfaces;
the knuckle includes a race engagement corner at the forward end surface of the pawl and having a contour with a non-constant radius; and/or
the contour is a conic blend having a conic shape with a Rho value between 0.1 and 0.9.

According to a third aspect of the present disclosure, there is provided a freewheel clutch, comprising a race and a pawl. The race includes a circumferential surface, and an array of circumferentially spaced notches in the circumferential surface. Each of the notches has: a radially facing root; circumferentially opposed first and second flanks extending between the root and the circumferential surface; and corner blends between the flanks and the circumferential surface. The pawl includes a leg and a knuckle. The leg extends from a rearward portion toward a forward portion, and the leg has: relatively radial inner and outer surfaces facing opposite directions; side surfaces facing opposite axial directions and extending between the radial inner and outer surfaces; a thickness between the radial inner and outer surfaces; and a width between the side surfaces greater than the thickness. The knuckle is at the forward portion of the leg and includes a forward end surface engageable with a first or second one of the flanks of each of the notches of the race in a detent position of the pawl with respect to the race. The knuckle is configured in cooperation with the notches of the race to restrain the pawl from advancing into the detent position at rotational speeds exceeding a detent-blocking rotational speed of the race relative to the pawl.

According to other aspects of the present disclosure, the freewheel clutch of the third aspect further includes any of the following features, including any technically-feasible combination of the following features
the knuckle of the pawl includes a detent-blocking protuberance being located longitudinally between the relatively radial outer surface of the leg and the forward end surface of the knuckle of the pawl and protruding in a radial direction away from the relatively radial outer surface of the leg of the pawl;
the knuckle also includes a spring-engaging protuberance extending longitudinally between a relatively radial inner surface of the leg and the forward end surface of the knuckle and protruding in a direction away from the relatively radial inner surface of the leg;
circumferential widths of the notches, radii of corner blends of the notches, and angular orientations of the flanks of the notches are configured to restrain the pawl from advancing into the detent position at rotational speeds exceeding a detent-blocking rotational speed of the race relative to the pawl;
the corner blends have contours with non-constant radii; and/or the contours are conic blends having a conic shape with a Rho value between 0.1 and 0.9.

### BRIEF DESCRIPTION OF THE DRAWINGS

FIG. 1 is a perspective view of an apparatus for coupling and decoupling rotational elements, illustrating a first axial-facing side of a clutch assembly of the apparatus that includes a first radial freewheel clutch and a second radial freewheel clutch.

FIG. 2 is a perspective view of the apparatus of FIG. 1 of a second axial-facing side of the clutch assembly, which is axially-opposite that of the first axial-facing side of the clutch assembly as shown in FIG. 1.

FIG. 3 is an axial view of the apparatus of FIG. 1, in particular, depicting the second axial-facing side of the clutch assembly of the apparatus of FIG. 2.

FIG. 4 is an enlarged, fragmentary, sectional view of the apparatus of FIG. 1, in particular, depicting the first radial freewheel clutch in an engaged state in which a pawl of a locking mechanism is engaged with a radially recessed relief of an outer race of the clutch assembly.

FIG. 5A is an axial view of the first axial-facing side of the clutch assembly of the apparatus of FIG. 1, in a state in which a retainer plate of an inner race of the clutch assembly is coupled to the first axial-facing side of the clutch assembly of FIG. 1.

FIG. 5B is an axial view of the first axial-facing side of the clutch assembly of the apparatus of FIG. 1, as shown in FIG. 5A except without depicting the retainer plate of FIG. 5A so as to show pawls, springs, and corresponding pawl and spring pockets of the inner race.

FIG. 6 is an enlarged, fragmentary, sectional view of the first axial-facing side of the apparatus of FIG. 1, with the retainer plate removed to reveal two radially-engaging actuatable pawl clutch mechanisms, each having a pawl and a spring disposed within the inner race with the pawl being radially displaceable for selective engagement with a notch within the outer race of the clutch assembly.

FIG. 7 is a rear tangential view of a relatively radially outward facing portion of a pawl for use in the second freewheel radial clutch, such as for the radially-engaging actuatable pawl clutch mechanisms depicted in FIGS. 5B and 6.

FIG. 8 is a radial view of the relatively radially outward facing portion of the pawl of FIG. 7.

FIG. 9 is a side view of the pawl of FIGS. 7-8.

FIG. 10 is a front tangential view of a relatively radially inward facing portion of the pawl of FIGS. 7-9.

FIG. 11 is an upper rear perspective view of the pawl of FIGS. 7-10.

FIG. 12 is an upper front perspective view of the pawl of FIGS. 7-11.

FIG. 13 is a perspective view of a torsional spring used for biasing a pawl or locking element radially outward as a part of the second freewheel radial clutch.

FIG. 14 is an enlarged, fragmentary, axial view of a first axially-facing side of the inner race along with pawl and spring pockets.

FIG. 15 is an enlarged, fragmentary, sectional, perspective view of the first axial-facing side of the apparatus of FIG. 1, in particular, depicting a first radially-engaging actuatable pawl clutch mechanism in a disengaged state in which the pawl of the inner race is in a radially-inward position.

FIG. 16 is an enlarged, fragmentary, sectional, perspective view of the first axial-facing side of the apparatus of FIG. 1, in particular, depicting a second radially-engaging actuatable pawl clutch mechanism in an engaged state in which the pawl of the inner race is disposed within a notch of the outer race.

FIG. 17 is an enlarged, fragmentary view of the first axial side of a pawl having a forward end surface proximate a notch of the outer race, and in a position where the pawl begins to fall into the notch.

FIGS. 18A-C each depict a forward end surface of a pawl or locking element, with FIG. 18A having a lower Rho value for its pawl engagement corner than that shown in FIG. 18B, and with FIG. 18C having an intermediate Rho value (between that of FIGS. 18A-B) shown disposed between dashed edges illustrating contouring of an edge of the pawl engagement corners of FIGS. 18A-B.

FIG. 18D is a graph illustrating curves for different Rho values, including those for an ellipse, parabola, and hyperbola.

FIGS. 19A-D each is an enlarged, fragmentary, side view of the first axially-facing side of the second freewheel radial clutch, in particular, depicting various embodiments of clutch engagements for the second freewheel radial clutch, namely those between a pawl engagement corner for a pawl and a corresponding notch of the outer race of the second freewheel radial clutch.

### DETAILED DESCRIPTION

In general, a radial freewheel clutch and pawl will be described using one or more examples of illustrative embodiments of a dynamic controllable clutch (DCC) that includes radially outwardly acting pawls and an electric controllable mechanical diode (eCMD) that includes a radially inwardly acting pawl. However, it will be appreciated as the description proceeds that the radial freewheel clutch and pawl are useful in many different applications and may be implemented in many other embodiments. In this regard, and as used herein and in the claims, it will be understood that a clutch and pawl are not limited to the particular radial directions disclosed herein, and may be oriented for radially inward engagement and/or radially outward engagement for any given application, and the eCMD may include multiple pawls that may be oriented circumferentially oppositely with respect to one another.

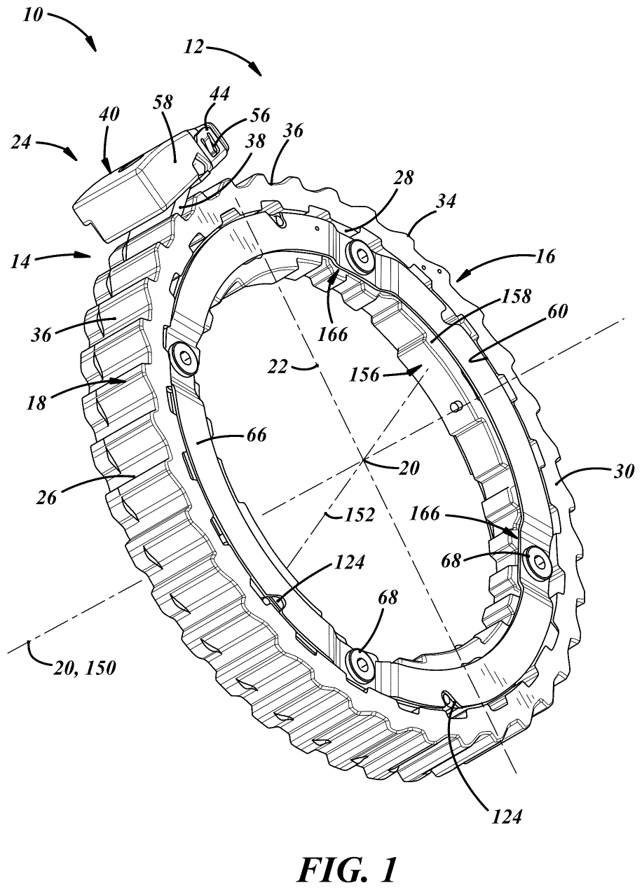

With reference now to the drawings, and to FIGS. 1-3 specifically, there is disclosed and illustrated an apparatus 10 for coupling and decoupling rotational elements, for example, input and output shafts, drums, hubs, planetary carriers, clutch plates, or any other suitable rotational elements (not shown). The apparatus 10 may include a clutch assembly 12 that may include one or more radial freewheel clutches, for example, a first radial freewheel clutch 14 and a second radial freewheel clutch 16. The clutches 14,16 are selectively actuatable such that the first radial freewheel clutch 14 may constitute an electrically controllable mechanical diode (eCMD), and the second radial freewheel clutch 16 may constitute an dynamic controllable clutch (DCC) that shares a common race with the eCMD, such that the entire apparatus 10 may constitute a combined eCMD/DCC apparatus.

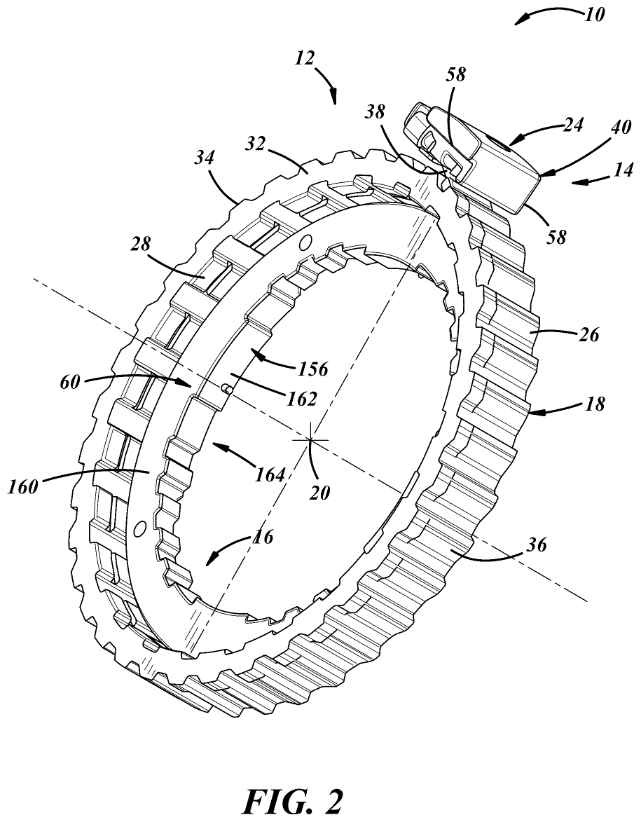

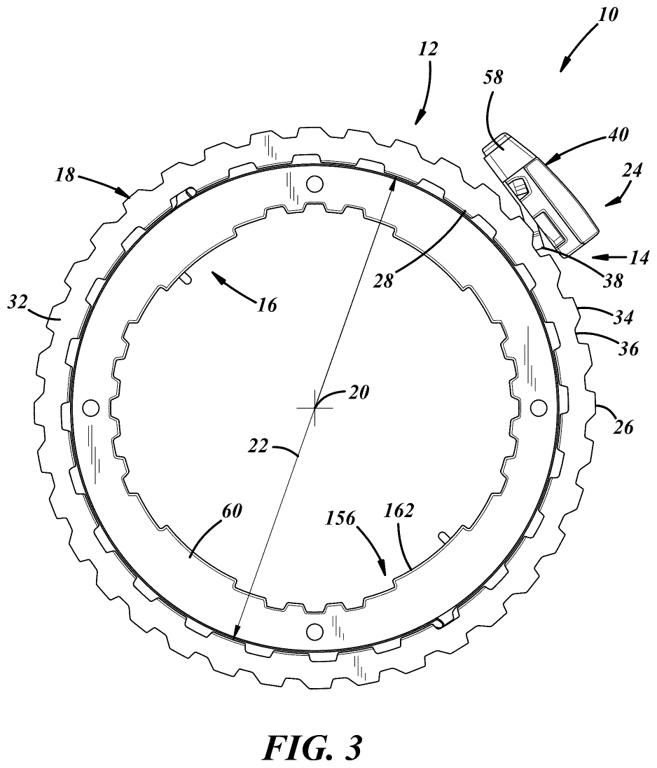

The first radial freewheel clutch 14 includes a first or outer race 18 that may be an annular or cylindrical component including a central axis 20 and a diameter 22 (FIG. 3) through the central axis 20, and a locking mechanism 24 that is selectively actuatable to stop rotation of the outer race 18 about the central axis 20 relative to the locking mechanism 24. The outer race 18 also includes a radially outer circumferential surface 26 facing in a radially outward direction, and a radially inner circumferential surface 28 facing in a radially inward direction opposite that of the radially outward direction. The outer race 18 further includes a first planar face 30 (FIG. 1) facing in a first axial direction, and a second planar face 32 (FIG. 2) facing in a second axial direction opposite that of the first axial direction. The radially outer circumferential surface 26 may include a radially outermost surface 34 that may be cylindrical, and may include one or more radially recessed reliefs (e.g., pawl notches) 36 in the radially outermost surface 34 to facilitate coupling of the outer race 18 to some other element. For example, the relief(s) 36 may include a circumferential array of radially external notches as shown in the illustrated embodiment, such that the outer race 18 may be referred to as a notch plate.

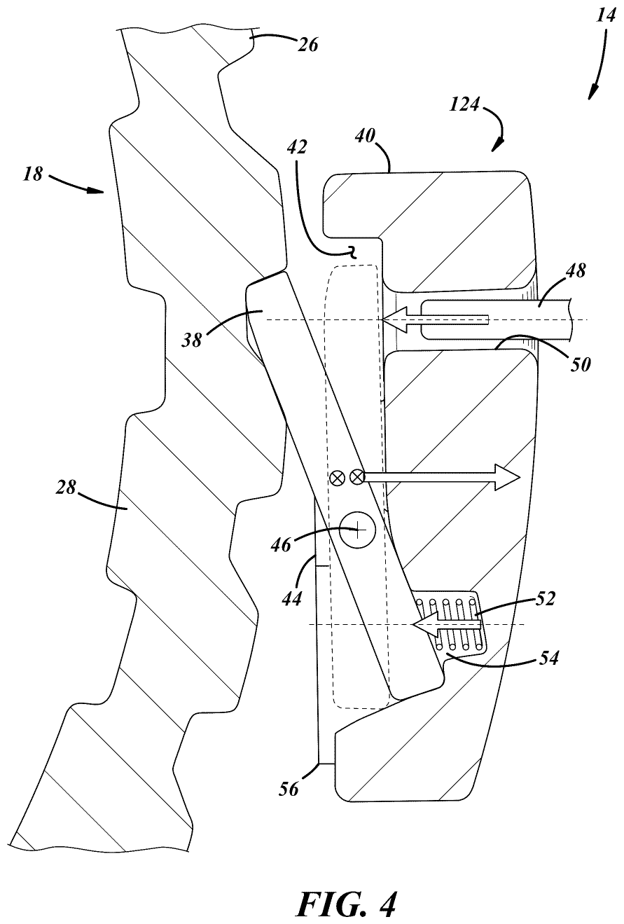

With reference now to FIG. 4, the locking mechanism 24 includes a locking element that may be a radial strut or pawl 38 that is selectively displaceable into and/or out of engagement with the outer race 18. The locking mechanism 24 also may include a pocket housing 40 establishing a pawl pocket 42 in which the pawl 38 is carried, a pawl retainer plate 44 to retain the pawl 38 in the pawl pocket 42 of the pocket housing 40, and the pawl 38 pivotably carried in the pocket 42 about a pawl pivot or pivot axis 46. The locking mechanism 24 further may include an actuation plunger (e.g., a compression spring or a rod) 48 carried in a through passage 50 of the housing 40 to move the pawl 38 toward an engagement position with respect to the outer race 18, and a return spring 52 carried in a spring pocket 54 of the housing 40 to bias the pawl 38 toward a disengagement position with respect to the outer race 18. The retainer plate 44 may be part of a retainer clip 56 that has axially opposite clip portions that frictionally interengage corresponding portions of axial sides 58 (FIGS. 1-2) of the pocket housing 40. The retainer plate 44 also may at least partially establish the pivot or pivot axis 46 of the pawl 38. The pocket housing 40 may be assembled and/or coupled to a larger housing, such as a clutch housing, transmission housing, or the like (not shown). Although not shown in the illustrated embodiment, the first clutch 14 also may include a pawl actuator that may drive the actuation plunger 48 into engagement and/or continued engagement with the pawl 38 to actuate the pawl 38 into the engagement position with respect to the outer race 18. The pawl actuator may include a solenoid, other electromechanical device, a hydromechanical device, or any other device suitable for use for actuating clutches.

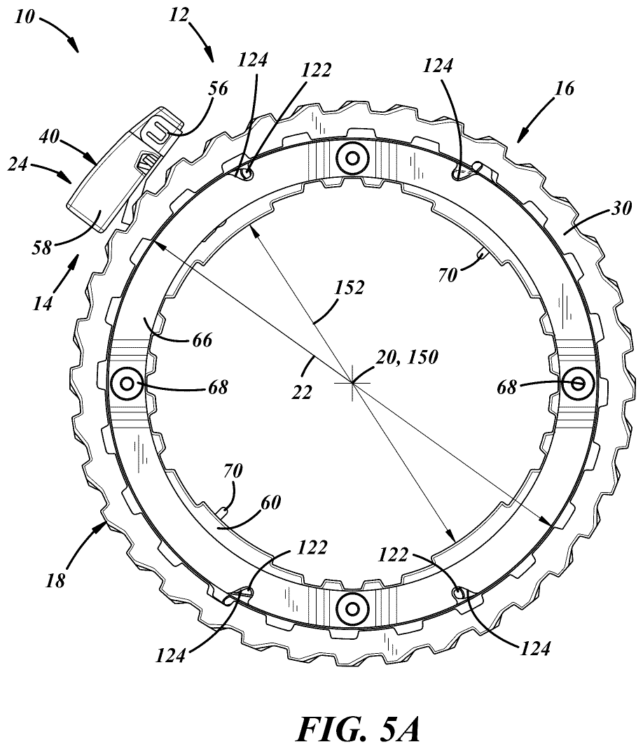

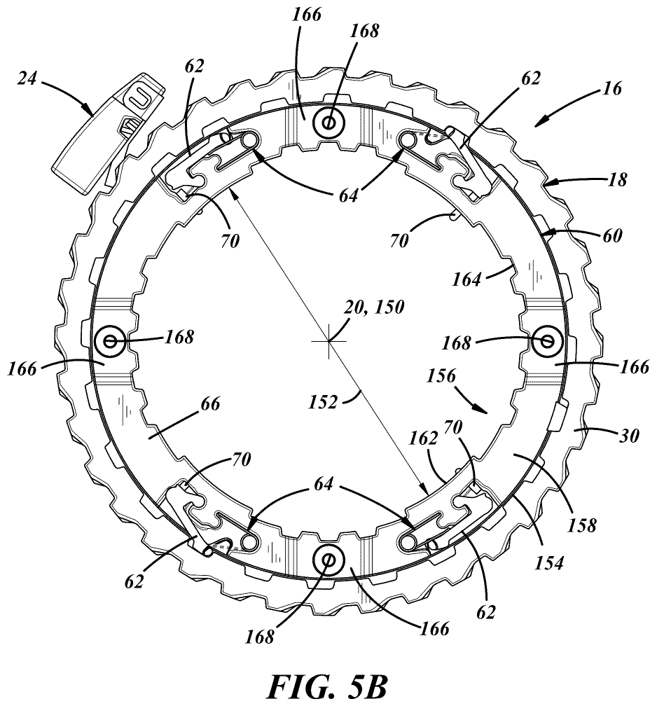

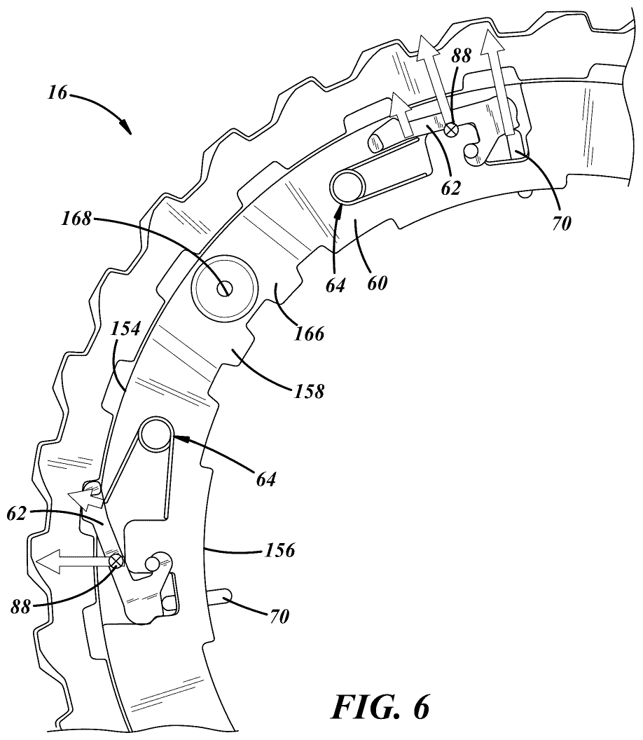

With reference now to FIGS. 5A-6, the second radial freewheel clutch 16 includes a second or inner race 60 for coupling to a rotational element (not shown), and the first or outer race 18 circumscribing the inner race 60. The second radial freewheel clutch 16 also includes a plurality of locking elements (FIG. 6B) that may be radial struts or pawls 62 that may be carried by the inner race 60 for selective engagement with and/or disengagement from the outer race 18, and a plurality of springs 64 (FIG. 5B) that may be carried by the inner race 60 to bias respective pawls of the plurality of pawls 62 toward engagement with and/or disengagement from the outer race 18. In the illustrated embodiment, the springs 64 (FIG. 5B) bias the pawls 62 toward a deployed position of the pawls 62 wherein the pawls 62 pivot and engage the outer race 18 either in detent engagement with the outer race 18 or in ratcheting or detent-blocking engagement with the outer race 18 as will be described herein below. The second radial freewheel clutch 16 further may include a retainer plate 66 (FIG. 5A) coupled to the inner race 60 to retain the pawls 62 and the springs 64, and fasteners 68 (FIG. 5A) to secure the retainer plate 66 to the inner race 60. The second radial freewheel clutch 16 additionally may include a plurality of actuator pins 70 to actuate the pawls 62 into and/or out of engagement with the outer race 18.

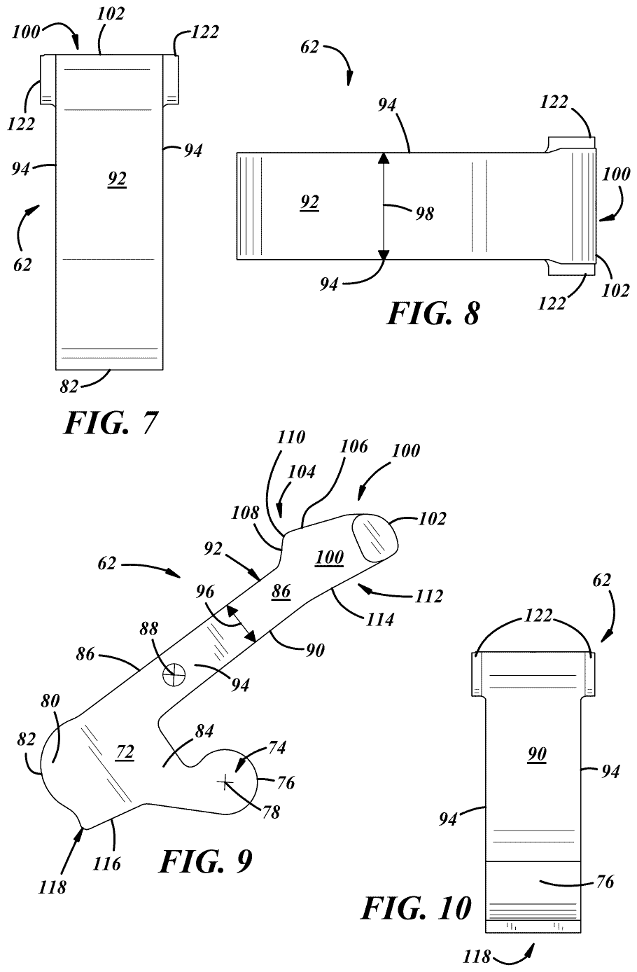

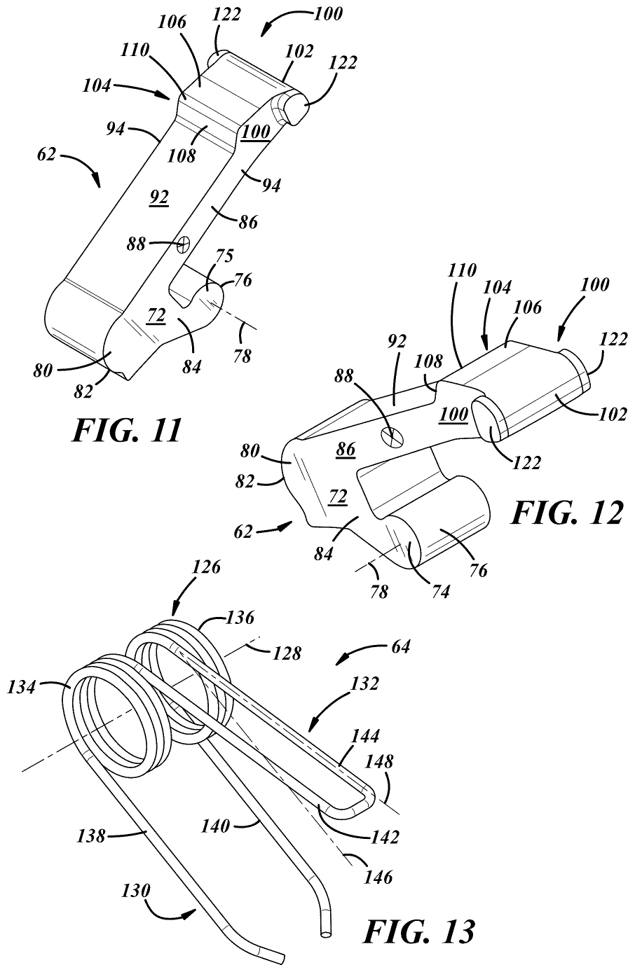

With reference now to FIGS. 7-12, each pawl 62 may include a foot 72 including a toe 74 having a pivot surface 76 that defines a pivot or pivot axis 78 of the pawl 62 and that may be semi-cylindrical, a heel 80 having a rear surface 82, and a medial portion 84 extending in a rearward direction away from the toe 74 and toward the heel 80. Also, each pawl 62 may include a leg 86 extending away from a rearward portion, for example, the heel 80, in a forward direction beyond the toe 74 toward a forward portion of the pawl 62, and having a center of gravity 88 disposed at a forward location of the pawl 62 relative to the pivot 78 of the pawl 62. The leg 86 may include relatively radial inner and outer surfaces 90, 92 facing opposite directions, and side surfaces 94 facing opposite axial directions and extending between the radial inner and outer surfaces 90, 92. The relatively radial outer surface 92 can be termed a relatively radially distal surface as it is distal with respect to the foot 72 of the pawl 62. The leg 86 also may include a thickness 96 (FIG. 9) between the radial inner and outer surfaces 90, 92, and a width 98 (FIG. 10) between the side surfaces 94 greater than the thickness 96. Further, each pawl 62 may terminate in a knuckle 100 extending away from the leg 86 and having a forward end surface 102.

As will be explained in further detail below with regard to the functionality of the clutch 16, and with particular reference to FIG. 9, the knuckle 100 may include a ratcheting or detent-blocking protuberance 104 located longitudinally between the relatively radial outer surface 92 of the leg 86 and the forward end surface 102 of the knuckle 100 and protruding in a direction away from the relatively radial outer surface 92 of the leg 86. The protuberance 104 may include a forward facing tapered surface 106, which may be a straight-tapered surface as illustrated or may be an excurvate-tapered or crowned surface. The protuberance 104 also may include a rearward facing tapered surface 108, which may be a straight-tapered surface as illustrated or may be an excurvate-tapered or crowned surface. A circumferential length of the forward facing tapered surface 106 generally may be longer than a circumferential length of the rearward facing tapered surface 108. A ratio of the length of the forward facing tapered surface 106 to the length of the rearward facing tapered surface 108 may be about 1.5:1, for instance between 0.75:1 and 3:1, including all ranges, sub-ranges, endpoints, and values therebetween, for example, between 1:1 and 2:1, or between 1.25:1 and 1.75:1. The protuberance 104 additionally may include a round or corner blend 110 between the forward facing and rearward facing tapered surfaces 106, 108. The rearward facing tapered surface 108 may be disposed at an angle that is steeper than that of the forward facing tapered surface 106. The corner blend 110 may have a fixed radius.

Likewise, and with continued reference to FIGS. 7-12, the knuckle 100 also may include a spring-engaging protuberance 112 located longitudinally between the relatively radial inner surface 90 of the leg 86 and the forward end surface 102 of the knuckle 100 and protruding in a direction away from the relatively radial inner surface 90 of the leg 86. The spring-engaging protuberance 112 may include a tapered surface 114 angled away from the relatively radially inner (proximate) surface 90 of the leg 86 and in a relative radial direction toward the foot 72 of the pawl 62 such that the knuckle 100 of the pawl 62 becomes thicker than the leg 86. The tapered surface 114 may be a straight-tapered surface as illustrated or may be an excurvate-tapered or crowned surface.

Moreover, the heel 80 may have a flat bottom surface 116 and a heel protuberance 118 between the rear and bottom surfaces 82, 116 of the heel 80, and the rear surface 82 of the heel 80 may be excurvate. Additionally, the pawl 62 may include the axially opposite side surfaces 94 and sensor lobes 122 protruding away from the axially opposite side surfaces 94, for example, as will be described in further detail herein below regarding functionality of the clutch 16. The sensor lobes 122 may extend away from the knuckle 100 of the pawl 62 as shown in the illustrated embodiment, or from the heel 80 in other embodiments. With reference to FIG. 5A, the retainer plate 66 may include sensor windows 124 corresponding to the sensor lobes 122 and, although not illustrated, the clutch 16 may include one or more sensors to sense when the sensor lobes 122 disappear from the sensor windows 124 of the retainer plate 66 to indicate that the pawls 62 are in deployed/engaged positions and when the sensor lobes 122 appear in the sensor windows 124 of the retainer plate 66 to indicate that the pawls 62 are in undeployed/disengaged positions.

With reference to FIG. 13, each torsion spring 64 may include a coil portion 126 with a coil axis 128 that may be oriented transversely with respect to a diameter of the race 60 (FIG. 5B). For example, the coil axis 128 may be substantially parallel to the rotational axis 20 of the race 60 and substantially perpendicular to the diameter of the race 60. As used herein with respect to angular orientation, the term “substantially” means within plus or minus ten angular degrees. Each torsion spring 64 also may include a first leg 130 extending away from the coil portion and bearing against the inner race 60, and a second leg 132 extending away from the coil portion 126 and bearing against the radial pawl 62. The torsion spring 64 may have a single coil, or any suitable quantity of coils but, in the illustrated embodiment, the torsion spring may be a double torsion spring that may include first and second coaxial coils 134, 136 axially spaced apart along the coil axis 128. The first leg 130 of the torsion spring 64 may be a split outboard reaction leg including a first portion 138 extending tangentially away from an axially outboard portion of the first coil 134 and a second portion 140 extending tangentially away from an axially outboard portion of the second coil 136. Conversely, the second leg 132 of the torsion spring may be a unitary inboard action leg including a first portion 142 extending tangentially away from an axially inboard portion of the first coil 134 and a second portion 144 extending tangentially away from an axially inboard portion of the second coil 136. Each torsion coil may include at least three complete revolutions. The first and second legs 130, 132 may have a compression angle 146 between −5° and 10° including all ranges, sub-ranges, endpoints, and values therebetween, for example, between 0° and 5°, and an extension angle 148 between 10° and 35° degrees including all ranges, sub-ranges, endpoints, and values therebetween, for example, between 15° and 30° degrees, or between 20° and 25° degrees. The torsion spring biases the radial pawl 62 in a radially outward direction with respect to the race 60.

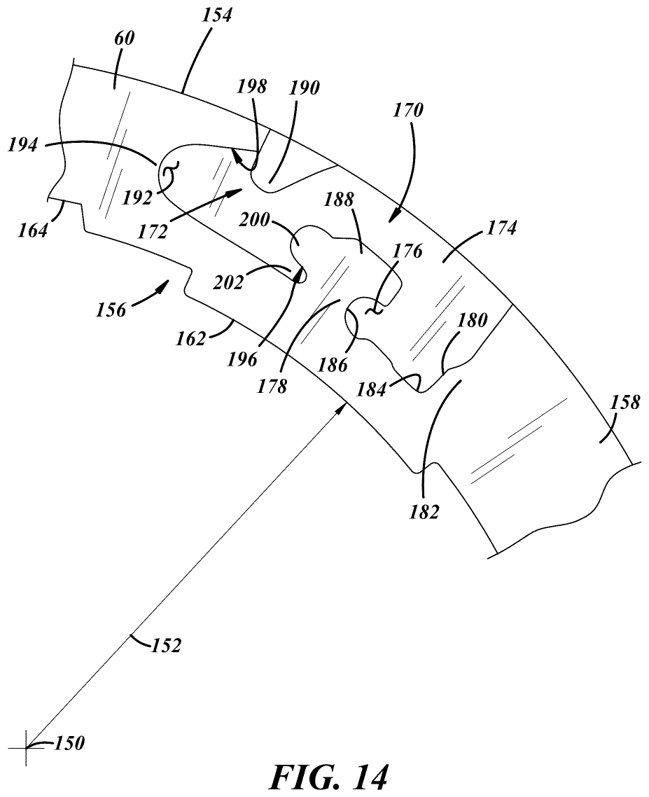

With reference to FIGS. 5B and 14, the inner race 60 may be an annular or cylindrical component, and includes a rotational axis 150 that may be coaxial with the central axis 20 of the outer race 18 (FIG. 5B), and an inner diameter 152 through the rotational axis 150, and may be referred to as a pocket plate. The inner race 60 includes a radially outer circumferential surface 154 facing in a radially outward direction, a radially inner circumferential surface 156 facing in a radially inward direction opposite that of the radially outward direction, a first planar face 158 facing in a first axial direction, and a second planar face 160 (FIG. 2) facing in a second axial direction opposite that of the first axial direction. The radially inner circumferential surface 156 may include a radially innermost surface 162 that may be cylindrical, and may include one or more radially recessed portions 164, which, in turn, may include one or more internal splines, for example, to facilitate coupling of the inner race 60 to some other rotational element. As best shown in FIG. 5B, the inner race 60 also may include one or more axial depressions 166 in the first planar face 158 and corresponding fastener passages 168 in the axial depressions 166. The fastener passages 168 may be threaded for cooperating with threads of the plate fasteners 68 of the retainer plate 66 (also referred to as “retainer plate fasteners 68”), and the axial depressions 166 may be shaped, sized, and/or otherwise configured to accommodate heads of the retainer plate fasteners 68.

With reference to FIGS. 14-16, the inner race 60 also includes one or more pawl pockets 170 and one or more spring pockets 172 between the first and second planar faces 158, 160. The pawl and spring pockets 170, 172 may be open to the first planar face 158, for example, to facilitate assembly of the pawls 62 and springs 64 therein. The pawl and spring pockets 170, 172 may include an axially facing internal side surface 174 that may be established by a portion of the inner race 60 itself as shown in the illustrated embodiment, or, in other embodiments, by a separate plate (not shown) coupled to the inner race 60 at the second planar face 160 (FIG. 2) of the race 60. The pawl pocket 170 may be open to the radially outer circumferential surface 154, and the spring pocket 172 may be open to the pawl pocket 170.

The pawl pocket 170 may include a pawl toe socket 176 at least partially defined by a pawl toe socket wall 178 of the race 60, a pawl heel seat 180 at least partially defined by a pawl heel seat wall 182 of the race 60 circumferentially opposed to the pawl toe socket 176, and an actuator pin gap 184 between the pawl toe socket 176 and a portion of the pawl 62, for instance, the heel 80 of the pawl 62 (FIG. 16). The pawl toe socket 176 may include a semi-cylindrical interior surface 186, for example, to facilitate retention and pivoting of the pawl 62 (FIG. 16) therein. The race 60 also may include a pawl stop 188 protruding radially outwardly with respect to the pawl toe socket wall 178 and shaped and located to abut the leg 86 of the pawl 62 to limit travel of the pawl 62. The race 60 additionally may include a pawl lobe pocket 190 that may be disposed in the axially facing internal side surface 174 of the pawl pocket 170. The pawl lobe pocket 190 may be shaped as illustrated in the drawings or may be of any other shape suitable to accommodate the sensor lobe 122.

With continued reference to FIGS. 14-16, the spring pocket 172 may include one or more of coil sockets 192, where each coil socket 192 is at least partially defined by a coil socket wall 194 of the race 60 to receive a coil portion of the torsion spring 64. The spring pocket 172 also may include a leg retainer 196 to retain the first leg 130 of the torsion spring 64, and a leg stop 198 to limit extension of the second leg 132 of the torsion spring 64. The leg retainer 196 may include a circumferentially extending protrusion 200 at least partially establishing a first leg socket 202 for the first leg 130 of the torsion spring 64.

In the illustrated embodiment, the race 60 additionally may include an actuator pin passage 204 (FIG. 16) extending through a portion of the race 60 and into the actuator pin gap 184 of the pawl pocket 170. The actuator pin passage 204 may extend radially through the radially innermost surface 162 of the race 60. Although not shown, the clutch 16 also may include a radially acting actuator to drive the actuator pin 70 in the actuator pin passage 204 into engagement and/or continued engagement with the pawl 62. In other embodiments, other actuators may be used to engage or further engage the pawl 62, for example, axially acting actuators including axial plungers with cam heads to radially displace the pawls 62. In still other embodiments, any type and configuration of actuators may be used to selectively actuate the pawls 62. In the illustrated embodiment, the actuator pins 70 are configured to be advanced radially outwardly to disengage the pawls 62 from the outer race 18.

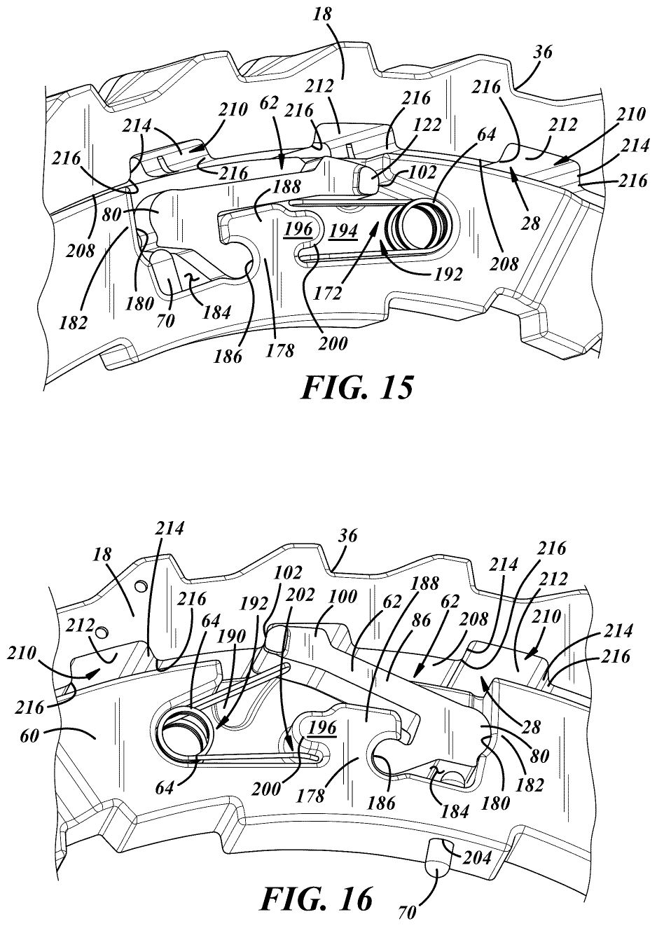

With continued reference to FIGS. 15 and 16, and in the illustrated embodiment, the outer race 18 may be rotatable in the same or opposite circumferential direction as the inner race 60 and/or may be fixed against rotation, for example, by being selectively locked with respect to a fixed housing (not shown) as will be described in further detail herein below. In other embodiments that may not include the eCMD, the outer race 18 may be merely fixed against rotation by being splined to the fixed housing or by being unitary with the fixed housing. In such embodiments, the reliefs 36 may be, instead of pawl notches, external splines for rotationally fixing the outer race 18 to the fixed housing which may include, for instance, a clutch housing, transmission housing, or any other suitable housing. The radially inner circumferential surface 28 may include a radially innermost surface 208 that may be cylindrical, and may include one or more notches 210. For example, the radially innermost surface 208 may include a circumferential array of the notches 210 to receive portions of the pawls 62 therein in deployed positions of the pawls 62 wherein the pawls 62 are advanced into detent with the notches 210 to facilitate coupling of the outer race 18 to the inner race 60. Each notch 210 may include a radially facing root 212, circumferentially opposed first and second flanks 214 extending between the root 212 and the radially innermost surface 208, and rounds 216 between the flanks 214 and the radially innermost surface 208.

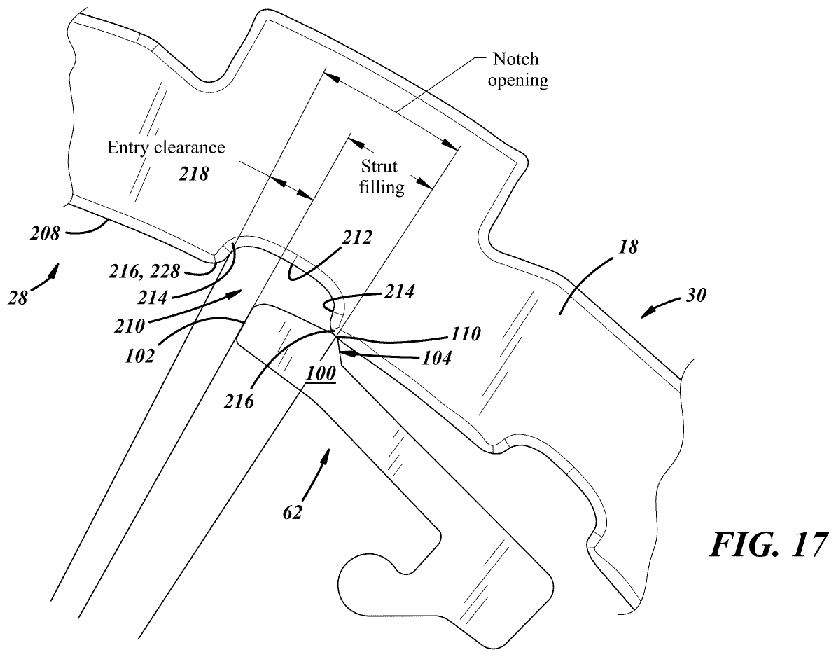

With reference now to FIG. 17, the pawls 62 and the notches 210 are configured in cooperation with one another to allow each pawl 62 to travel (rise or fall) into circumferential engagement with each notch 210 in a detent position. Each pawl 62 includes the forward end surface 102 engageable with a corresponding one of the flanks 214 of each of the notches 210 of the race 18 in the detent position. Additionally, each pawl 62 includes a portion that is located rearwardly of the forward end surface 102 and radially oppositely of the toe 74, wherein that portion bottoms out against the root 212 of the notch 210.

The pawls 62 and the notches 210 are also configured in cooperation with one another to control an available circumferential window of detent engagement between the pawls 62 and the notches 210 at rotational speeds exceeding a ratcheting or detent-blocking rotational speed of the outer race 18 relative to the pawls 62. As used herein, the terms “ratcheting” and “detent-blocking” are used interchangeably. The pawls 62 may “ratchet” or operate in a “ratchet” state when a relative rotational speed between the pawls 62 and corresponding race 18 is at a magnitude sufficient to block or prevent the pawls 62 from falling into detent into the notches 210 of the race 18 to stop relative rotational motion between the races 18, 60. Instead of falling into detent into the notches 210, the pawls 62 skip relatively circumferentially across the notches 210, thereby allowing continued relative motion between the races 18, 60. The term “ratcheting” can also be used to describe a clutch or pawl associated with a ratchet state. For example, a clutch may be ratcheting, a pawl may be ratcheting, or a pawl may be ratcheting pawl. Different pawl and notch configurations, shapes, and/or feature sizes may enable a pawl to ratchet. For example, a configuration of the pawls 62 and/or the notches 210 prevents the deployed pawls 62 from falling into detent into corresponding notches 210 until the relative rotational speed between the races 18, 60 is achieved wherein that speed is safe for such detent engagement, for example, such that the pawls 62 and/or races 18, 60 will not break, be damaged, or the like. Conversely, the pawls 62 ratchet at relative rotational speeds between the races 18, 60 above that safe relative rotational speed.

For example, detent engagement of the pawls 62 into the notches 210 may occur at a relative rotational speed between the races 18, 60 of 500 RPM or less, for instance, 300 to 500 RPM including all ranges, sub-ranges, endpoints, and values therebetween, more specifically, between 325 and 475 RPM, or between 350 and 450 RPM, or between 375 and 425 RPM. In another example, detent engagement of the pawls 62 into the notches 210 may occur at a relative rotational speed between the races 18, 60 of 300 RPM or less, for instance, 100 to 300 RPM including all ranges, sub-ranges, endpoints, and values therebetween, more specifically, between 125 and 275 RPM, or between 150 and 250 RPM, or between 175 and 225 RPM. In a further example, detent engagement of the pawls 62 into the notches 210 may occur at a relative rotational speed between the races 18, 60 of 100 RPM or less, for instance 50 to 100 RPM including all ranges, sub-ranges, endpoints, and values therebetween, more specifically, between 25 and 75 RPM. In another example, detent engagement of the pawls 62 into the notches 210 may occur at a relative rotational speed between the races 18, 60 of 50 RPM or less. More specifically, each knuckle 100 may include the detent-blocking protuberance 104, which, relative to the notches 210 of the outer race 18, may be located on the pawl 62, sized relative to the notches 210, and/or shaped relative to the notches 210 in a manner that results in the knuckle 100 being blocked—at speeds above a desired detent-blocking rotational speed—from entering the notches 210 to an extent that would allow the pawl 62 to fall into detent with the outer race 18. The particular location, geometry, and/or size of the protuberance 104 may be modified to achieve desired detent-blocking capability. In another example, circumferential widths of the notches 210, radial depths of the notches 210, radii of the rounds 216 of the notches 210, and/or angles of the flanks 214 of the notches 210 may be configured to restrain the pawl 62 from advancing into the detent position at rotational speeds exceeding a detent-blocking rotational speed of the outer race 18 relative to the pawl 62.

Even more specifically, to reduce or even minimize the rotational speed at which the pawl 62 will enter into detent (circumferentially drivingly engage) with respect to the notches 210, it may be desirable to reduce or even minimize an entry clearance angle 218 between the forward end surface 102 of the pawl 62 and the corresponding circumferentially opposed flank 214 of the notch 210 and/or increase or even maximize corner blends or “rounds” of corresponding portions of the pawl 62 and/or of the notches 210, particularly, at least in the present embodiment, for the corner blend 110 of the pawl 62 and those corresponding rounds 216 of the notches 210. As illustrated, the entry clearance angle 218 can be measured when the pawl 62 is at a circumferential location where the pawl 62 begins to travel (fall or rise) into the notch 210 as shown in FIG. 17. At that location, there is a corresponding radial distance that the pawl 62 can pivot without the pawl 62 entering into detent with the notch 210 such that the clutch 16 may be in a ratcheting mode. The entry clearance angle 218 may be between 0.1 and 10 degrees including all ranges, sub-ranges, endpoints, and values therebetween, for example, between 0.5 and 5 degrees, or between 1 and 2 degrees.

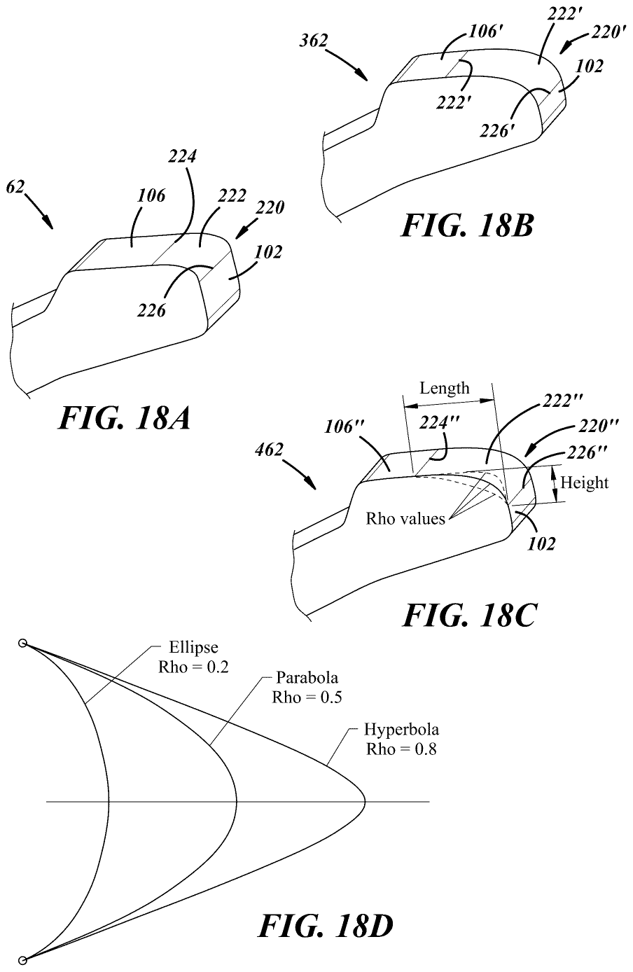

With reference to FIG. 18A, a race engagement corner 220 at the forward end surface 102 of the pawl 62 (and radially opposite of the toe 74) can be configured with a contour 222 that extends from the forward end surface 102 of the pawl 62 to a rearward end 224 of the contour 222. The rearward end 224 of the contour 222 may terminate at the forward facing tapered surface 106 of the detent-blocking protuberance 104. The contour 222 simply may be a “round” with a constant radius as is typically provided on clutch components. As illustrated, however, the contour 222 may have a non-constant radius, for example, a variable radius, and may be a conic blend having a conic shape with a Rho value between 0.1 and 0.9, including all ranges, sub-ranges, endpoints, and values therebetween, for example, between 0.2 and 0.8, or between 0.4 and 0.6. More specifically, the conic shape may be elliptical, parabolic, or hyperbolic. The pawl 62 illustrated in FIG. 18A has an elliptical shape with a Rho value of 0.2. FIG. 18B illustrates another pawl 362 having a race engagement corner 220′ with a different contour 222′ of hyperbolic shape with a Rho value of 0.8. FIG. 18C illustrates another pawl 462 having a race engagement corner 220″ with a different contour 222″ of parabolic shape with a Rho value of 0.5.

Also, the race engagement corners 220, 220′, 220″ may have a length that may extend from the forward end surface 102 of the pawls 62, 362, 462 to the rearward ends 224, 224′, 224″ of the contours 222, 222′, 222″, and a height that may extend from the rearward ends 224, 224′, 224″ of the contours 222, 222′, 222″ and junctures 226, 226′, 226″ between the forward end surface 102 and the contours 222, 222′, 222″. The length may be between 0.25 and 6 mm, including all ranges, sub-ranges, endpoints, and values therebetween, for example, between 0.5 and 4 mm, or between 1 and 2 mm. The height may be between 0.25 and 3 mm, including all ranges, sub-ranges, endpoints, and values therebetween, for example, between 0.5 and 2 mm, or between 1 and 1.5 mm. A ratio of the length to the height may be between 3:1 and 1.5:1, including all ranges, sub-ranges, endpoints, and values therebetween, for example, between 2.5:1 and 2:1.

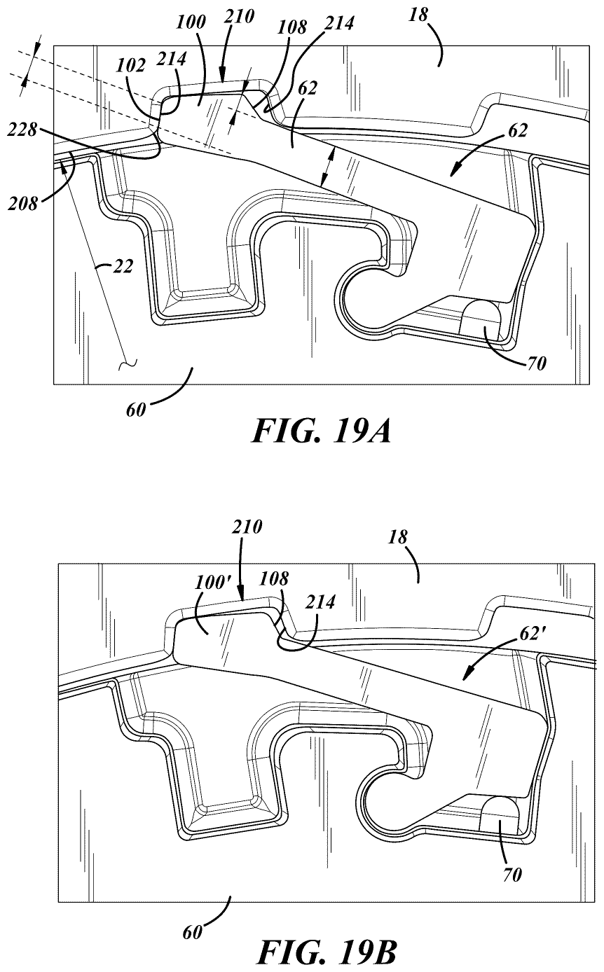

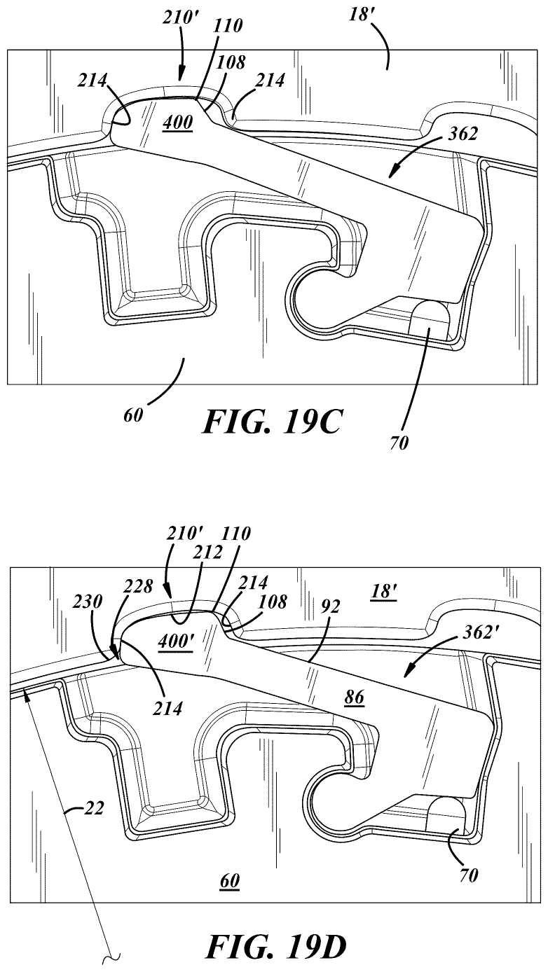

With reference now to FIG. 19A, a pawl engagement corner 228 at the open end of the notch 210 (as opposed to the closed or root end of the notch 210) between a notch flank 214 and the radially innermost surface 208 of the outer race 18 can be configured with a contour that extends from the notch flank 214 to the race inner diameter 22. The contour simply may be a “round” with a constant radius as is typically provided. As illustrated, however, the contour may be as described above with respect to the contour 222 of the race engagement corner 220 of the pawl 62. The shape and size of the pawl engagement corner 228 of the outer race 18 can be identical to or different from the shape and size of the race engagement corner 220 of the pawl 62. When it is desired to increase strength of corners between the notch root 212 and the notch flank 214, however, it may be desirable to incorporate a majority of the quantifiable corner blending into the pawl 62 rather than the outer race 18.

The radial extent of the detent-blocking protuberance 104 can be increased or even maximized to obtain the desired entry clearance angle. The radial extent of the detent-blocking protuberance 104 can be measured from the relatively radially outer surface 92 of the leg 86 to the corner blend 110 of the protuberance 104. A ratio of the radial extent of the protuberance 104 to the radial extent of the forward end surface 102 of the pawl 62 may range from 0.5:1 to 2:1, including all ranges, sub-ranges, endpoints, and values therebetween. A ratio of the radial extent of the protuberance 104 to the radial extent or thickness 96 of the leg 86 of the pawl may range from 0.25:1 to 0.75:1, including all ranges, sub-ranges, endpoints, and values therebetween, for example, between 0.4:1 and 0.6:1.

With reference to FIGS. 19A-19D, the circumferential extent of the portion of each pawl 62, 62′, 362, 362′ (including the detent-blocking protuberance 104) that occupies the notch 210, 210′ when the pawl 62, 62′, 362, 362′ is in the detent position in the notch 210, 210′ can be sized to occupy a desired amount of the circumferential extent of the notch 210, 210′ on average over the radial extent of the notch 210, 210′. That desired amount may be between 82% and 94% including all ranges, sub-ranges, endpoints, and values therebetween, for example, between 85% and 91%, or between 87% and 89%. Gaps vary between flanks 214 of the notches 210, 210′ and surfaces 108 of knuckles 100, 100′, 400, 400′ of the pawls 62, 62′, 362, 362′ which may have knuckles 100, 100′, 400, 400′ of different circumferential dimensions to occupy less or more of the corresponding notches 210, 210′.

Although not illustrated, the pocket plate and notch plate functionality may be reversed such that the outer race may be a pocket plate including pockets and radially inwardly acting pawls and springs carried in the pockets, and such that the inner race may be a notch plate including radially outer notches configured to cooperate with the pawls.

Moreover, the presently disclosed dynamic controllable clutch may be configured such that the pawl can move into engagement/detent with the outer race up to a desired rotational speed of the inner race, for example, about 4,000 RPM, and will stay in engagement/detent with the outer race up to a desired rotational speed of the inner and outer race, for example, at least 7,000 RPM and up to 15,000 RPM. Those of ordinary skill in the art would recognize that the particular rotational speed thresholds will vary greatly from application to application depending on a variety of variables including pawl size, geometry, center of gravity location relative to pawl pivot, spring force, notch configuration, and the like. Nonetheless, the present teachings are applicable to a wide variety of applications to provide improved clutch performance.

As used in herein, the terminology “for example,” “e.g.,” for instance,” “like,” “such as,” “comprising,” “having,” “including,” and the like, when used with a listing of one or more elements, is to be construed as open-ended, meaning that the listing does not exclude additional elements. As used herein, permissive terms like “may” and “can” are expedients merely to indicate optionality, for instance, of a disclosed embodiment, element, feature, or the like, and should not be construed as rendering indefinite any disclosure herein. Moreover, directional words such as front, rear, top, bottom, upper, lower, radial, circumferential, axial, lateral, longitudinal, vertical, horizontal, transverse, and/or the like are employed by way of example and not necessarily limitation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. A clutch, comprising:
a race including a rotational axis and a diameter extending through the rotational axis;
a radial pawl carried by the race; and
a torsion spring carried by the race and including
a coil portion with a coil axis oriented transversely with respect to the diameter of the race,
a first leg extending away from the coil portion and bearing against the race, and
a second leg extending away from the coil portion and bearing against the radial pawl.

2. The clutch of claim 1, wherein the torsion spring biases the radial pawl in a radially outward direction with respect to the race.

3. The clutch of claim 1, wherein a coil axis of the torsion spring is substantially parallel to the rotational axis of the race and substantially perpendicular to the diameter of the race.

4. The clutch of claim 1, wherein the torsion spring is a double torsion spring including
first and second coils axially spaced apart along the coil axis,
wherein the first leg of the torsion spring is a split outboard reaction leg including a first portion extending tangentially away from an axially outboard portion of the first coil and a second portion extending tangentially away from an axially outboard portion of the second coil, and
wherein the second leg of the torsion spring is a unitary inboard action leg including a first portion extending tangentially away from an axially inboard portion of the first coil and a second portion extending tangentially away from an axially inboard portion of the second coil.

5. The clutch of claim 4, wherein the first and second coils each include at least three complete revolutions.

6. The clutch of claim 4, wherein the first and second legs have a compression angle between −5° and 10° and an extension angle between 10° and 35° degrees.

7. The clutch of claim 1, wherein the race includes
a radially outer circumferential surface,
a radially inner circumferential surface,
a first planar face,
a second planar face,
a pawl pocket between the first and second planar faces, and
a spring pocket between the first and second planar faces and open to the pawl pocket, and having a coil socket to receive the coil portion of the torsion spring.

8. The clutch of claim 7, wherein the spring pocket also has a leg retainer to retain the first leg of the torsion spring.

9. The clutch of claim 8, wherein the leg retainer includes a circumferentially extending protrusion establishing a first leg socket for the first leg of the torsion spring.

10. The clutch of claim 7, wherein the spring pocket also has a leg stop to limit extension of the second leg of the torsion spring.

11. The clutch of claim 7, wherein the pawl pocket includes
a pawl toe socket having a semi-cylindrical interior surface,
a pawl heel seat circumferentially opposed to the pawl toe socket, and
an actuator pin gap between the pawl toe socket and the pawl heel seat.

12. The clutch of claim 11, wherein the race also includes:
a pawl toe socket wall at least partially defining the pawl toe socket, and
a pawl stop protruding radially outwardly with respect to the pawl toe socket wall to limit travel of the pawl.

13. The clutch of claim 11, wherein the race also includes an actuator pin passage extending radially through a portion of the race and into the actuator pin gap of the pawl pocket.

14. The clutch of claim 11, wherein the radial pawl includes
a toe carried in the pawl toe socket and having a semi-cylindrical pivot surface cooperative with the semi-cylindrical interior surface of the pawl toe socket,
a heel having a rear surface engageable with the pawl heel seat, and
a leg extending away from the heel beyond the toe and terminating in a knuckle having a detent-blocking protuberance.

15. The clutch of claim 14, wherein the heel has a flat bottom surface and a protruberance between the bottom and rear surfaces of the heel, and wherein the rear surface of the heel is excurvate and the pawl heel seat is incurvate.

16. The clutch of claim 1, further comprising:
a second race circumscribing the race and including an internal array of circumferentially spaced notches to receive a portion of the radial pawl in a deployed position of the radial pawl.

17. The clutch of claim 16, wherein the race is rotatable about the rotational axis and the second race is also rotatable about the rotational axis in the same or opposite circumferential direction with respect to the race.

18. The clutch of claim 17, further comprising:
an outward radial pawl disposed radially outward with respect to the second race and having an engagement end configured to engage an external array of circumferentially spaced notches of the second race in a deployed position of the outward radial pawl.

19. The clutch of claim 18, wherein the radial pawls are selectively actuatable such that the clutch constitutes an integrated dynamic controllable clutch (DCC) and electrically controllable mechanical diode (eCMD).

20. The clutch of claim 1, further comprising a retainer plate coupled to an axially facing side surface of the race, and having a sensor window.

21. The clutch of claim 1, wherein the race includes an axially facing internal side surface facing an axially facing side surface of the radial pawl, and a lobe pocket in the axially facing internal side surface.

22.-32. (canceled)
